(19) United States
(12) Patent Application Publication
(10) Pub. No.: US 2023/0302778 A1
(43) Pub. Date: Sep. 28, 2023

(54) Stretch Film Comprising A Slip Skin Layer

(71) Applicant: Paragon Films, Inc., Broken Arrow, OK (US)

(72) Inventors: Tom ROUDEBUSH, Broken Arrow, OK (US); Shaun Pirtle, Coweta, OK (US); Mike Hildreth, Broken Arrow, OK (US); George Eichbauer, Broken Arrow, OK (US)

(73) Assignee: Paragon Films, Inc., Broken Arrow, OK (US)

(21) Appl. No.: 18/203,366

(22) Filed: May 30, 2023

Related U.S. Application Data
(63) Continuation of application No. 17/465,290, filed on Sep. 2, 2021, now abandoned.
Application No. 17/465,290 is a continuation of application No. 17/150,844, filed on Jan. 15, 2021, now abandoned.
Application No. 17/150,844 is a continuation of application No. 16/895,702, filed on Jun. 8, 2020, now abandoned.
(60) Provisional application No. 62/858,673, filed on Jun. 7, 2019.

(51) Int. Cl. B32B 27/08; B32B 27/32; B32B 27/40

(52) U.S. Cl. CPC B32B 27/08; B32B 27/32; B32B 27/40; B32B 2307/51; B32B 2307/746; B32B 2307/732; B32B 2250/24; B32B 2270/00

(57) ABSTRACT

Methods and means for producing a stretch film comprising a slip skin layer are provided. In one example embodiment, a stretch film having a slip skin layer is provided having a variable and scalable coefficient of friction. A stretch film comprising a cling layer and a slip skin layer is also provided, in which the cling layer further with includes a polyethylene-based elastomer blended into a low density polyethylene, and the slip skin layer includes an ultra-high molecular weight polysiloxane polymer. Consequently, the slip skin layer has a very low coefficient of friction while the cling layer retains a relatively high co-efficient of friction.

### CROSS-REFERENCES TO RELATED APPLICATIONS

This patent application claims benefit of U.S. patent application Ser. No. 17/465,290, filed Sep. 2, 2021, which claims benefit of U.S. patent application Ser. No. 17/150,844, filed Jan. 15, 2021, May 17, 2017, which claims benefit of U.S. patent application Ser. No. 16/895,702, filed Jun. 8, 2020, which claims the benefit of U.S. Provisional Patent Application No. 62/858,673, filed Jun. 7, 2019, the contents of which are hereby incorporated by reference in their entirety.

### TECHNICAL FIELD

The present invention relates generally to methods and means for producing a stretch film comprising a slip skin layer, and in a particular though non-limiting embodiment, to a stretch film comprising a slip skin layer having a variable and scalable coefficient of friction.

### BACKGROUND

A wide variety of bundling and packaging applications employ stretch films. For example, machine and hand stretch films are, frequently used to secure bulky loads such as boxes, merchandise, produce, equipment, parts and other similar items on pallets.

Loads and pallets wrapped with stretch film are often loaded next to one another on trucks, trains, ships and the like, for storage, loading and transportation. Consequently, the outermost layer of stretch film encasing such loads and pallets physically contacts that of neighboring loads and pallets. This contact results in pallet-to-pallet distortions and product damage during loading and transit.

Such distortions and damage can lead to inadequate wrapping integrity and even ultimate failure; make it difficult for end users to unwind and use the rolled film; and prevent the slip performance coefficient of friction from being maintained within a desired range. To date, no known prior art resolves, lessens or apparently even contemplates a solution to these important considerations.

There is, therefore, a longstanding but currently unmet need for stretch films providing adequate wrapping integrity and maintaining a suitable slip coefficient of friction, while avoiding the deleterious performance characteristics of the prior art.

### SUMMARY

The present invention is drawn to a stretch film comprising a cling layer and a slip skin layer, wherein the cling layer further comprises a polyethylene-based elastomer blended into a low density polyethylene, and the slip skin layer comprises an ultra-high molecular weight polysiloxane polymer. Consequently, the slip skin layer has a very low coefficient of friction while the cling layer retains a relatively high co-efficient of friction.

In essence, the stretch film disclosed herein incorporates a slip skin layer on one side of the stretch film. The slip skin layer significantly improves the stretch film's field performance by reducing contact and friction between wrapped materials.

In one example embodiment the stretch film further comprises a low film-to-film coefficient of friction. In a further example embodiment the stretch film further comprises a moderate cling. In a still further example embodiment the stretch film further comprises a non-migratory cling. In yet another example embodiment the stretch film comprises a non-migratory slip.

In a further example embodiment the stretch film comprises a high load holding force. In another example embodiment the stretch film comprises a high elongation. In still another example embodiment the stretch film comprises a good clarity.

In general, the stretch film comprising a slip skin layer differs from known one-sided cling films by minimizing pallet-to-pallet distortion and product damage caused by contact and friction during transport and storage. Moreover, the stretch film further admits to underside pallet wrapping as an additional measure to prevent product damage, thereby further reducing costs.

In a presently preferred embodiment, the stretch film comprises a slip skin layer with a low coefficient of friction and provides a good clarity, and a moderate cling.

In a particular though non-limiting embodiment, the coefficient of friction of the slip skin layer is less than or equal to around 1.0. In another embodiment, the coefficient of friction of the slip skin layer is less than or equal to 0.8. In yet another embodiment, the coefficient of friction of the slip skin layer is less than or equal to 0.6.

In another embodiment, the slip skin layer comprises an ultra-high molecular weight polysiloxane polymer. In a further embodiment, the slip skin layer comprises a dosed 25% loaded masterbatch. In a further embodiment, the slip skin layer comprises a dosed 50% loaded masterbatch. In a specific though non-limiting embodiment, the slip skin layer comprises a dosed 25% loaded masterbatch further comprising an ultra-high molecular weight polysiloxane reacted with a polypropylene polymer.

In yet another embodiment, the slip skin layer comprises a non-migratory urethane. Ordinarily skilled artisans will readily appreciate that in other embodiments the slip skin layer will comprise a plurality of other non-migratory additives.

In another embodiment, the slip skin layer further comprises a polyolefin resin, including at least a polyethylene resin, polypropylene resin and combinations thereof. According to other embodiments, the slip skin layer further comprises random co-polymer polypropylene.

Ordinarily skilled artisans will readily appreciate that further embodiments of the slip skin layer can also comprise a plurality or mixture of resins. Such artisans will also appreciate that further embodiments of the slip skin layer comprising a wide variety of additives combined with a plurality of polyolefin resins are inherently disclosed herein.

In another embodiment, the cling layer comprises a lesser amount of cling additive. In other embodiments, the cling layer comprises a polyethylene-based elastomer blend, e.g., between about 25% and about 75% by weight in a linear low density polyethylene. In a further embodiment, the cling layer comprises an m-polypropylene elastomer resin.

In another embodiment, the stretch film comprises a plurality of layers. In some embodiments, the stretch film comprises a plurality of slip skin layers disposed in communication with one or more additional internal layers, e.g., layers selected to correspond to film properties desired by the end user. in one specific though non-limiting embodiment, the film comprises between 2 and 7 layers, though those of skill in the art will appreciate that a larger number of layers are inherently contemplated and disclosed herein. In other embodiments, the, film comprises between 8 and 25 layers. and in still other embodiments the film comprises between 26 and 49 layers. In certain embodiments, the film comprises a great many additional layers, viz, as many as 50 or more additional layers.

In one example embodiment, the skin layer comprises between about 4% and about 25% of the total thickness of the film. and the internal layers comprise between about 60% and about 85% of the total film thickness.

According to other embodiments, the total thickness of the film is greater than 25 microns. In a particular though non-limiting embodiment, the total thickness ranges between about 8 microns and about 50 microns. In another particular though non-limiting embodiment, the total thickness of the film is less than about 13 microns. In specific example, the film thickness is about 10 microns.

According to one example embodiment, the slip layer is incorporated into machine film. In other embodiments, the slip layer is incorporated into hand film or other types of stretch film.

In yet another embodiment, the stretch film wraps a load such that the slip skin layer is the outer layer of the film. Thus, when two loads wrapped with the film interact, contact and friction are minimized, thereby decreasing the amount of pallet-to-pallet distortion and product degradation. In still further embodiments, the slip layer is used in high elongation or high loading force film structures. According to certain embodiments, the slip skin layer maintains slip functionality over a stretch range from between about 0% and about 350%.

The foregoing specification is provided only for illustrative purposes, and is not intended to describe all possible aspects of the present invention. While the invention has herein been shown and described in detail with respect to several exemplary embodiments, those of ordinary skill in the art will appreciate that minor changes to the description, and various other modifications, omissions and additions may also be made without departing from the spirit or scope thereof.

1. A stretch film comprising a slip skin layer, wherein said stretch film further comprises a slip skin layer having a variable and scalable coefficient of friction.
